(19) United States
(12) Patent Application Publication
(10) Pub. No.: US 2026/0359649 A1
(43) Pub. Date: Nov. 12, 2026

(54) TESTING DATA ON SOFTWARE APPLICATIONS BASED ON PRIVACY LAW

(71) Applicant: International Business Machines Corporation, Armonk, NY (US)

(72) Inventors: SARIKA SINHA, Bangalore (IN); SIDDHARTH K. SARAYA, Raniganj (IN)

(21) Appl. No.: 19/202,466

(22) Filed: May 8, 2025

(51) Int. Cl. G06N 3/09

(52) U.S. Cl. CPC G06N 3/09

(57) ABSTRACT

An approach for defining data sets for each API (application program interface) and providing these data based on live data, after applying the data privacy laws, to be used in testing software applications may be provided. The approach retrieving dataset and classifying the dataset based on a sensitivity rating. The approach allows a data pruner to mask dataset that has been classified as highly sensitive. The approach transmits the masked data to the data provisioner to be used as test data.

### TECHNICAL FIELD

The present invention relates generally to software development, and specifically, for testing software applications with privacy complaint test data.

### BACKGROUND

Developers develop the software based on the requirements. After the code is developed, the next task is testing of the software. There are various types of testing, such as, acceptance testing, system testing, integration testing and unit testing. While performing these tests, the test data is mainly driven by, at least, the following factors: i) understanding of the feature by the developers and testers and ii) understanding of the system by the developers and testers.

### BRIEF SUMMARY

According to an embodiment of the present invention, a computer-implemented method for defining data sets for each API (application program interface) and providing these data based on live data, after applying the data privacy laws, to be used in testing software applications, the computer-implemented method comprising: retrieving a dataset from one or more servers; classifying the dataset, by data privacy analyzer module, based on a sensitivity rating; transmitting a first plurality of data from the dataset that has been designated as highly sensitive, based on exceeding a sensitivity threshold, to a data pruner; transmitting a second plurality of data from the dataset that has been classified as low sensitivity, based on a sensitivity threshold, to a data provisioner; masking the first plurality of data, by the data pruner; transmitting the masked first datum to the data provisioner then transmitting, by the data provisioner; and transmitting, by the data provisioner, the second data to be used as test data to a target server.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

Other aspects and embodiments of the present invention will become apparent from the following detailed description, which, when taken in conjunction with the drawings, illustrate by way of example the principles of the invention.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a computing environment 100, including data testing manager 150, according to embodiments of the present invention;

FIG. 2 depicts further details of data testing manager 150, including submodules, such as API definition 202, data privacy analyzer 204, data pruner 206 and data provisioning 208, according to embodiments of the present invention;

FIG. 3 is a block diagram illustrating a system level interaction between various modules and processes, designated as 300, according to embodiments of the present invention; and

FIG. 4 illustrates a flowchart, as one embodiment, depicting the execution of data testing manager 150 as method 400.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms "a," "an" and "the" include plural referents unless otherwise specified. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof.

In the current art of software development, specifically testing software applications, there are issues with generating and/or assembling data for testing purposes. For example, some test data, such as “live data” may not be accessible or available from the client. One reason that the test data may not be available is due to data privacy laws applicable to that country. Thus, there is a need to apply data privacy laws intelligently to various test datasets before it can be used to test software applications. The current disclosure, through various embodiments, proposes an approach for defining the important datasets for each API and providing these datasets based on live data (after applying the data privacy laws) to be used in testing software applications.

The approach has the capability, but is not limited to, allowing users (i.e., developers) to define critical data for each application programming interface (API), allow users (e.g., business analyst, system experts, etc.) to define data privacy policy for the data, allow users (i.e., data pruner) to apply rules (i.e., data privacy policy from users) and allow a smart data provisioning (SDP) system to generate test data for APIs.

Some advantages associated with the above approach, may include, but are not limited to, i) ability to use the live data for testing APIs, ii) ability to define the critical input parameters for each API, iii) ability to make the data compliant by meeting the data privacy laws and iv) ability to meet the requirements of testing the features effectively.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

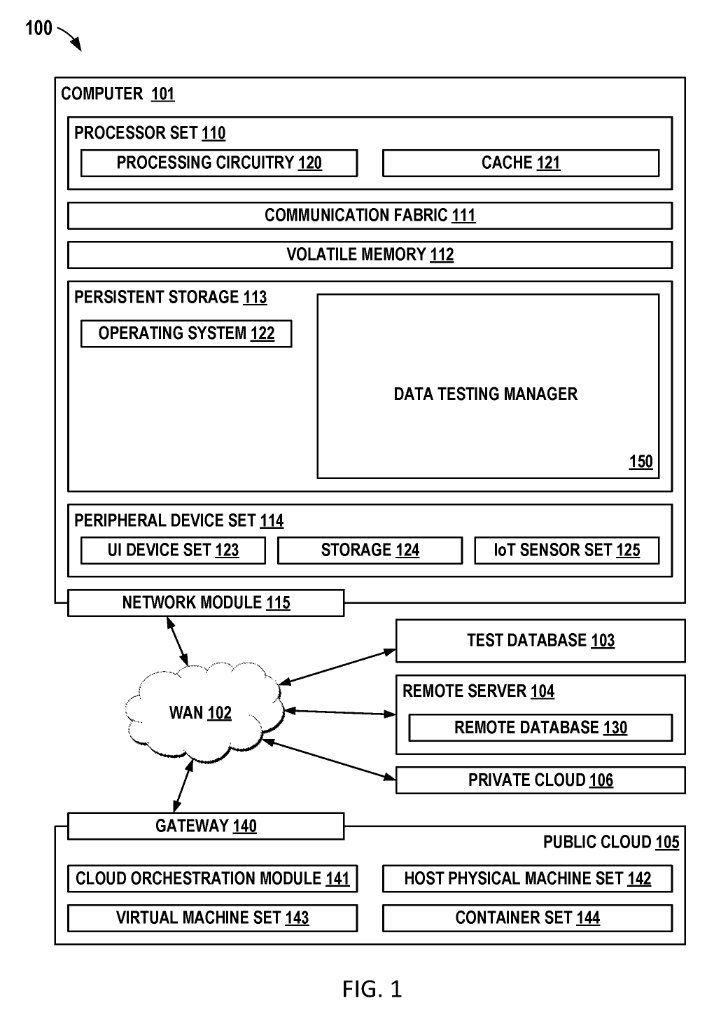

FIG. 1 includes computing environment 100, which contains an example of an environment for the execution of at least some of the computer code involved in performing the inventive methods. Computing environment 100 includes, for example, computer 101, WAN (wide area network) 102, Test database 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data testing manager 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computing environment 100 contains an example of an environment for the execution of at least some of the computer code involved in performing the inventive methods, such as data testing manager 150. In addition to data testing manager 150, computing environment 100 includes, for example, computer 101, wide area network (WAN) 102, Test database 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data testing manager 150, as identified above), peripheral device set 114 (including user interface (UI) device set 123, storage 124, and Internet of Things (IoT) sensor set 125), and network module 115. Remote server 104 includes remote database 130 and target server (not pictured), wherein the target server is a server used for testing purposes. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data testing manager 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in data testing manager 150 typically includes at least some of the computer code involved in performing the inventive methods.

Data testing manager 150 provides the following capabilities, but it is not limited to, define critical data for each application programming interface (API), allow users (e.g., business analyst, system experts, etc.) to define data privacy policy for the data, allow users (i.e., data pruner) to apply rules (i.e., data privacy policy from users) and allow a smart data provisioning (SDP) system to generate test data for APIs. It is noted that data testing manager 150 may reside on test database 103 or may reside on another device within computing environment 100.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is a collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

Test database 103 is a repository of datasets to be used to test software applications. The datasets can contain, but it is not limited to, live data (i.e., from production servers), test data (e.g., data used for initial testing) and various other datasets, deemed necessary by the users (e.g., developers, unit testers, etc.).

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

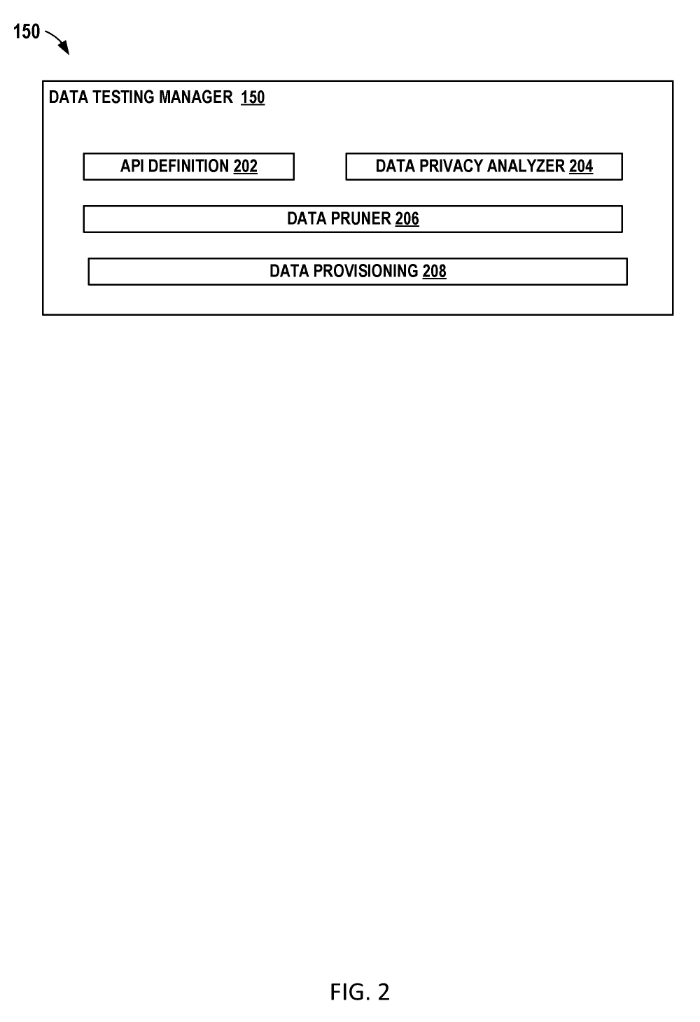

FIG. 2 depicts further details of data testing manager 150, which includes sub-modules, such as, API definition 202, data privacy analyzer 204, data pruner 206 and data provisioning 208.

API definition 202 is a sub-module that is capable of allowing users to create definitions of data inputs for a particular API. An example of an API with a generic function will be used, such as, “function (param1, param2, param3)”. For this generic API function, it may be only “param1” that is the critical data which changes the way the API works, and the rest of the data can be any data available. In another example function, such as, “getCustomerLoanAgibilty (customerId, age, salary),” may contain parameters/data that are not critical. For example, “customerId” may not be as critical as the eligibility amount of loan for a customer is decided based on age and salary. Thus, “age” and “salary” can be defined as the critical data for this API function.

Data privacy analyzer 204 is a rules-based sub-module for discerning and identifying data columns and data items that may violate data privacy law for that particular country/region. Thus, users would program and define the privacy rules into sub-module 204 as it relates to APIs. For example, “customerId” can be defined as the regulated data and “age” and “salary” not combined with customerId can be used. This a critical definition as a combination of “customerId” and “age” is regulated data (i.e., prohibited by data privacy laws/regulations). However, the “age” part can be used independently as these are the sample “ages” for which this API is getting frequently called in the software. Similar rules for “salary” and can be used without “customerId” but can be combined with “age” to get an understanding that which age group with what salary are using this API.

Other functions of data privacy analyzer 204 include designating various datasets (e.g., live data, test data, columns of tables, etc.) based on a sensitivity rating and creating a sensitivity threshold. For example, certain columns from a dataset/data tables can be designated as “highly sensitive” since it includes information that has been deemed as personal identifiable (PI) information such as, “customerId,” “Full_Name” and “age.” It is noted that not every jurisdiction may view the same information as PI. Therefore, a sensitive rating can include, at least, “high” and “low” status/rating.

Furthermore, a sensitivity threshold (i.e., predefined and pre-configured by the user/admin) is used as a quantitative measurement of the dataset to determine whether the columns/data is considered “highly sensitivity” or “low sensitivity” (i.e., converting from a qualitative value to a quantitative value). Thus, “high sensitive” or “highly sensitive” data would be given a numerical value between 6 to 10 and “low sensitive” data would be given a numerical value between 1 to 5. Thus, the sensitivity threshold can be set (by a system admin user) to a value of 7, wherein any data columns exceeding that threshold would be deemed “highly sensitive” and/or regulated by applicable data privacy laws.

Data privacy analyzer 204 can execute many algorithms to perform its function. One example is the “Data Privacy Analyzer Algorithm,” which will be discussed below. An example of high-level steps of the algorithm (data privacy analyzer algorithm) can be summarized by the following:
Sensitivity data is fed in the system using supervised learning.
The individual column attributes or combination of attributes are designated with a sensitive value (e.g., low or high).
These are mapped to the security policy which designates them as sensitive and/or regulated.

Other functionality of data privacy analyzer 204 includes a self-training and refinement sub-module. The purpose is due to the possible changes to the security policies (e.g., laws change, etc.) and the attributes that need to be revisited for an update. Similarly for new attributes getting added to the database, analysis of the attribute individually and in combination with other attributes is done to identify the sensitivity values/rating. Furthermore, individual column attributes and combinations of multiple column attributes are analyzed for intent of the column(s) for sensitivity.

The high-level operational steps (of the self-training and refinement sub-module) are summarized by the following:
Analyzed intent is mapped to location / company / client attribute security policy.
All the individual columns and combinations that have been identified as sensitive are stored and passed on to the data pruner algorithm
Attributes like description, comments, etc. are classified as unstructured (i.e., unstructured data) since the intent for these column attributes would not present a clear picture.
Each unstructured cell data is analyzed, before passing on the content to pruner algorithm.

Data pruner 206 is a sub-module that is capable of removing and/or masking data that are deemed sensitive (i.e., violation of privacy data law) from an originating dataset (e.g., live data, production data, etc.). Furthermore, after “removing” the regulated data from the live data then the “cleansed” data can be used for data provisioning. In the example that was previously mentioned, “customerId” will be removed but “age” and “salary” will be kept. Some of the high level steps includes, i) feeds of sensitivity classification are received from Data Privacy Analyzer sub-module ii) data flow feed maps are analyzed to see the columns are being populated from production server to the lower environments, iii) column(s) marked sensitive (i.e., highly sensitive or exceed a sensitivity threshold) are removed from the feeds of direct mapping and iv) live feed of sensitive data is first parsed through the data masking algorithm and then as per the data feed to the lower environments and the process repeats for additional columns that have been designated as “highly sensitive.”

It is noted that some terms, such as, “cleansed,” “pruned,” “cleaned,” “masked,” “masking” and “removing” may be used interchangeably throughout this disclosure but denotes the process (i.e., by using a data masking algorithm) of anonymizing of data. Any existing techniques for anonymizing data can be used, such as but not limited to, data masking, pseudonymization, generalization, tokenization, data redaction, differential privacy, hashing, k-anonymity, data perturbation, data swapping, data concealment, bucketing and creating synthetic data.

Data provisioning 208 (also known as “data provisioner”) is a sub-module that is capable of aggregating data from data pruner 206 sub-module and provides the data to be used for testing. For example, after retrieving the data from a live feed and cleansed by data pruner 206, data provisioning 208 sub-module can select other data from the field of the relevant data table to generate inputs for an API.

Other functionality of the data provisioning sub-module 208 can include, but it is not limited to, directing data feeds between various server environments (e.g., production, testing, development, etc.) which may include live data and moving other data (either cleaned or uncleaned) for testing purposes.

Data provisioning 208 can execute many algorithms to perform its function. One example of an algorithm is the “Data Provisioning Algorithm,” which will be discussed below. An example of high-level steps of the algorithm (data provisioning algorithm) can be summarized by the following:
Data marked as non-sensitive are taken as live feeds directly from production to lower environments. This is done by the mapping made in the ETL flow or the DB scripts.
For highly sensitive data, data feeds from the Data Pruner Algorithm are used instead of directly from uncleaned sources.
The cleaned data is then passed from the data masking algorithm to the data flows and can be validated to ensure the cleaned data meets the sensitivity compliance policies.
For unstructured data, each cell is parsed by the data pruner algorithm. Each cell content is tested for sensitive information. For example, patterns like “Employee Id – 12344”, “Address – ABC Road, XHHJY – 67652”. If these contents are identified, then the cell data is masked and then passed on to the lower environment. If no sensitive information is identified data is passed directly passed through from production to lower environments.

### Use Case Scenario

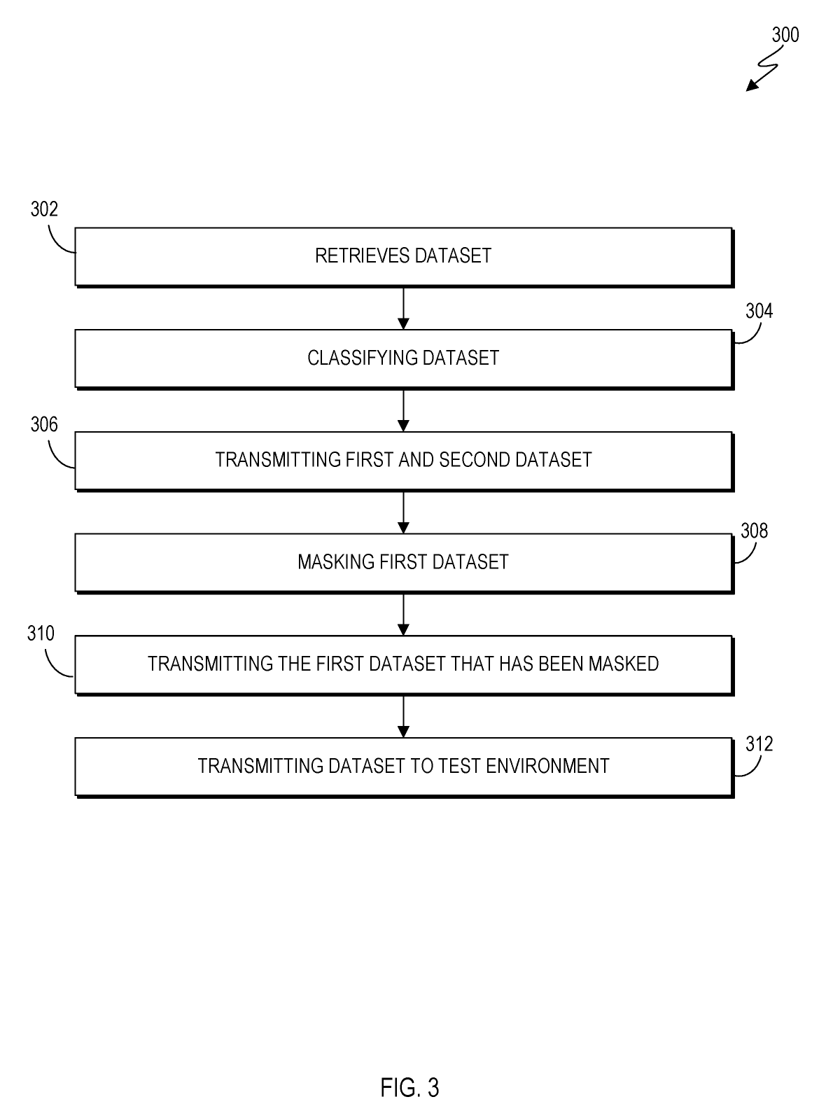

An example use case scenario will be used to illustrate data testing manager 150. A global bank (known as “BANK”) needs a new application for their customers and commissions software developers to create a new application. The new application will allow customers to manage online banking and shopping easier. The data used will primarily come from the customer. This customer data may contain sensitive information in addition to financial related data. Hence, the entire data set from the customers cannot be shared and used based on the constraints (i.e., country data privacy laws and regulations) for software testing. However, there are issues with anonymizing the data, using existing methods, such as replacing one or two digits with a random character, for data testing. First, it would not be entirely helpful (i.e., anonymizing) since it doesn’t allow for testing in all scenarios. The second issue with using anonymized data (i.e., from production server) is that the sheer volume of data can be quite large, and the dataset may have some breaches built in. Thus, an embodiment of the present invention offers a novel approach to facilitate data testing of a software application by manifesting the data in a manner that complies with the law of data security and privacy. Furthermore, the approach can ensure that all the testing scenarios of data are covered. It is noted that steps from FIG. 3 can be used to illustrate the above use case scenario.

FIG. 3 illustrates a flowchart, as one embodiment, depicting the execution of data testing manager 150 as method 300.

At operation 302, data testing manager 150 retrieves dataset to be tested. The dataset can be retrieved from test database 103 or from databases selected by the user. For example, referring to the BANK scenario, the dataset can come from customer data and other financial transactions relating to the customer.

At operation 304, data testing manager 150, through data privacy analyzer 204 and API definition 202, classifies the dataset based on a sensitive rating. The sensitive values are “low sensitivity” and “high sensitivity.” For example, referring to the BANK scenario, data and/or columns, such as, customer name and age relating to PI (personal identifiable) information of the customer can be designated as “high sensitivity.”

At operation 306, data testing manager 150 transmits the dataset to be processed by data pruner sub-module for the dataset that exceeds a sensitivity threshold (i.e., high sensitivity). For example, referring to the BANK scenario, columns, such as customer name and age will be processed by data pruner sub-module.

At operation 308, data testing manager 150 transmits the dataset to the data provisioning sub-module for the dataset that does not exceed a sensitivity threshold (i.e., low sensitivity). For example, referring to the BANK scenario, columns, such as “transaction date” and “amount” will not be process by the data pruner sub-module and will be sent to the data provisioning sub-module.

At operation 310, data testing manager 150, through the data pruner 206 sub-module, cleans the dataset and transmits the cleaned dataset to data provisioning sub-module.

At operation 312, data testing manager 150, through data provisioning 208 sub-module, manages and transmits the dataset to various destinations for testing.

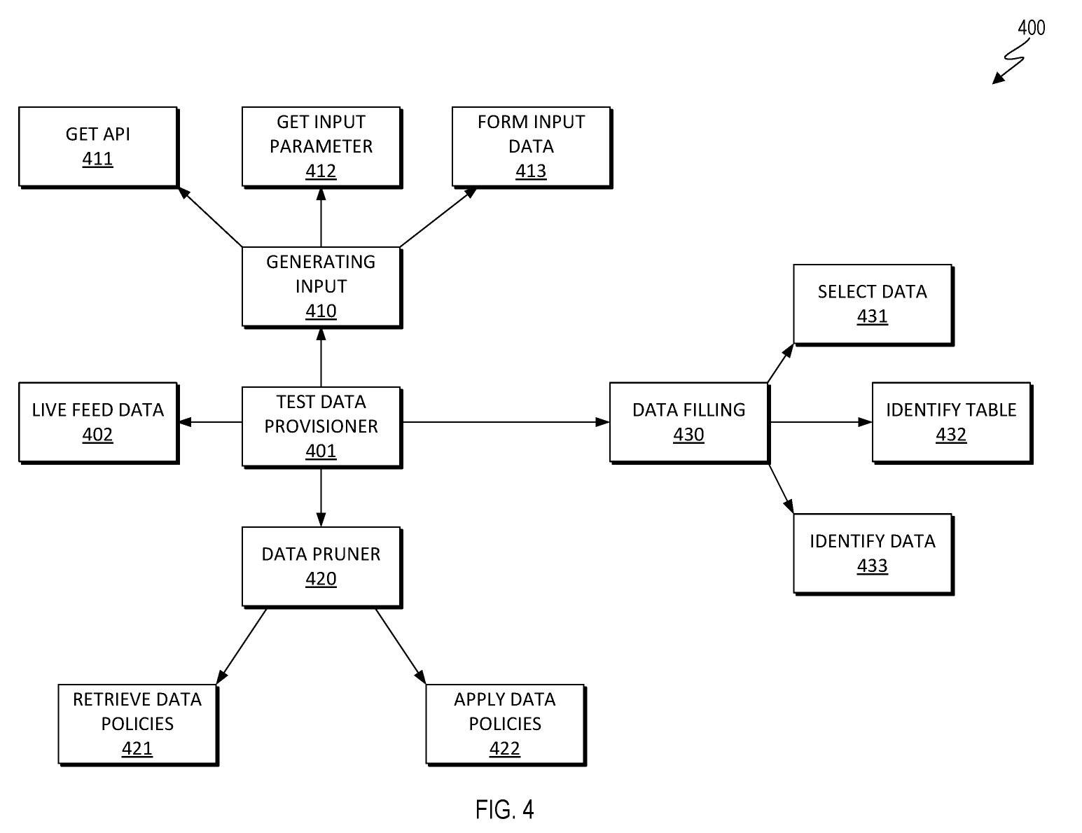

FIG. 4 is a block diagram illustrating system level interaction between various modules and processes, designated as 400, according to embodiments of the present invention.

Referring to FIG. 4, there are four major steps: i) generating inputs (i.e., 410), ii) filling data (i.e., 430), iii) data pruning (i.e., 407) and iv) provisioning of test data (i.e., 406).

### Generating inputs

This process (generating input 410), leveraging at least API definition 202 sub-module and data privacy analyzer 204 sub-module, involves defining the API, retrieving input parameters list and generating inputs based after combining pruned data and table data. Get API 411 and get input parameters 412 are initial steps for drafting and finalizing data inputs and parameters for the inputs. Form input data 413 is a step relating to generating data after the data has been pruned (i.e., 407) and is further combined with data from the data tables.

### Filling in data

This process (e.g., steps 430 - 433) primary involves generating data for testing (after it has data definition/parameters have been defined and relevant data privacy laws have been analyzed). The subprocess (i.e., 431 - 433) includes selecting relevant data fields (step 431), identifying relevant tables (step 432) and identifying required data for testing (step 433).

### Data pruning

Data pruner 420, leveraging at least data pruner 206 sub-module and data privacy analyzer 204 sub-module, primary involves cleaning test data based on the applied data policy. The subprocesses (e.g., 421 - 422) include retrieving data policies (step 421) and applying data policies (step 422).

### Provisioning of test data

Test data provisioner 406, leveraging data provisioning 208 sub-module, primary involves managing the flow of test data (inputs and outputs). Live data is fed at step 402 and test data provisioner 401 utilizes at least the following steps, generating input (step 410), data filing (step 430) and data pruner (step 420).

1. A computer-implemented method, comprising:
retrieving a dataset from one or more servers;
classifying the dataset, by data privacy analyzer, based on a sensitivity rating;
transmitting a first plurality of data from the dataset that has been designated as highly sensitive, based on exceeding a sensitivity threshold, to a data pruner;
transmitting a second plurality of data from the dataset that has been classified as low sensitivity, based on a sensitivity threshold, to a data provisioner;
masking the first plurality of data, by the data pruner;
transmitting the masked first datum to the data provisioner then transmitting, by the data provisioner; and
transmitting, by the data provisioner, the second data to be used as test data to a target server.

2. The computer-implemented method of claim 1, wherein the data privacy analyzer is configured to classify the dataset by supervised learning techniques and is configured to map one or more security policies to the dataset.

3. The computer-implemented method of claim 1, wherein the data provisioning is configured to map non-sensitive data between environments and is configured to manage data flows between locations.

4. The computer-implemented method of claim 1, wherein the data pruner is configured to remove columns designated as sensitive from a direct mapping and is configured to
anonymize the datasets.

5. The computer-implemented method of claim 1, wherein the dataset that is designated as highly sensitive further includes PI (personal identifiable) information.

6. The computer-implemented method of claim 1, wherein and the sensitivity rating has values of “high” and “low”.

7. The computer-implemented method of claim 1, wherein the first data is cleaned data and the second data is live data.

8. A computer program product, comprising:
one or more non-transitory computer-readable storage media and program instructions stored on the one or more non-transitory computer-readable storage media capable of performing a method, the method comprising:
retrieving a dataset from one or more servers;
classifying the dataset, by data privacy analyzer, based on a sensitivity rating;
transmitting a first plurality of data from the dataset that has been designated as highly sensitive, based on exceeding a sensitivity threshold, to a data pruner;
transmitting a second plurality of data from the dataset that has been classified as low sensitivity, based on a sensitivity threshold, to a data provisioner;
masking the first plurality of data, by the data pruner;
transmitting the masked first datum to the data provisioner then transmitting, by the data provisioner; and
transmitting, by the data provisioner, the second data to be used as test data to a target server.

9. The computer program product of claim 8, wherein the data privacy analyzer is configured to classify the dataset by supervised learning techniques and is configured to map one or more security policies to the dataset.

10. The computer program product of claim 8, wherein the data provisioning is configured to map non-sensitive data between environments and is configured to manage data flows between locations.

11. The computer program product of claim 8, wherein the data pruner is configured to remove columns designated as sensitive from a direct mapping and is configured to anonymize the datasets.

12. The computer program product of claim 8, wherein the dataset that is designated as highly sensitive further includes PI (personal identifiable) information.

13. The computer program product of claim 8, wherein and the sensitivity rating has values of “high” and “low”.

14. The computer program product of claim 8, wherein the first data is cleaned data and the second data is live data.

15. A computer system, comprising:
one or more computer processors;
one or more computer-readable storage media, and program instructions stored on the one or more of the computer-readable storage media for execution by at least one of the one or more processors capable of performing a method, the method comprising:
retrieving a dataset from one or more servers;
classifying the dataset, by data privacy analyzer, based on a sensitivity rating;
transmitting a first plurality of data from the dataset that has been designated as highly sensitive, based on exceeding a sensitivity threshold, to a data pruner;
transmitting a second plurality of data from the dataset that has been classified as low sensitivity, based on a sensitivity threshold, to a data provisioner;
masking the first plurality of data, by the data pruner;
transmitting the masked first datum to the data provisioner then transmitting, by the data provisioner; and
transmitting, by the data provisioner, the second data to be used as test data to a target server.

16. The computer system of claim 15, wherein the data privacy analyzer is configured to classify the dataset by supervised learning techniques and is configured to map one or more security policies to the dataset.

17. The computer system of claim 15, wherein the data provisioning is configured to map non-sensitive data between environments and is configured to manage data flows between locations.

18. The computer system of claim 15, wherein the data pruner is configured to remove columns designated as sensitive from a direct mapping and is configured to anonymize the datasets.

19. The computer system of claim 15, wherein the dataset that is designated as highly sensitive further includes PI (personal identifiable) information.

20. The computer system of claim 15, wherein and the sensitivity rating has values of “high” and “low”.
